(19) United States
(12) Patent Application Publication
(10) Pub. No.: US 2009/0298425 A1
(43) Pub. Date: Dec. 3, 2009

(54) Communication System for Data Interchange Between Electrical Installation Engineering Appliances

(76) Inventors: Martin Dietz, Tegernheim (DE); Michael Ernst, Zeitlarn (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/087,618

(22) PCT Filed: Dec. 8, 2006
(86) PCT No.: PCT/EP2006/069456

§ 371 Date: Jan. 23, 2009

(30) Foreign Application Priority Data
Jan. 12, 2006 (DE) 10 2006 001 654.8

(51) Int. Cl. H04B 5/00

(52) U.S. Cl. 455/41.1

(57) ABSTRACT

To provide a communication system for data interchange between electrical appliances in electrical installation engineering which is distinguished by a simple topology and low installation complexity, provision is made for quasi-stationary electrical fields with a high-frequency AC current to be used to achieve signal coupling to electrically conductive element which are present in the installation arrangement for the purpose of capacitive near-field communication.

### CROSS REFERENCE TO RELATED APPLICATIONS

This application is the US National Stage of International Application No. PCT/EP2006/069456, filed Dec. 8, 2006 and claims the benefit thereof. The International Application claims the benefits of German application No. 10 2006 001 654.8 DE filed Jan. 12, 2006, both of the applications are incorporated by reference herein in their entirety.

### FIELD OF INVENTION

The invention relates to a communication system for exchanging data between electrical appliances in electrical installation engineering.

### BACKGROUND OF INVENTION

A communication system of this type is used inter alia to query, display and if applicable influence switching or function states of appliances or appliance groups. By way of example, the switching or function states of the appliances can be made available to an authorized professional at a central control center. This allows targeted measures to be introduced in order to eliminate fault states or also to activate and/or deactivate electric circuits. It is also essential to set up function links between appliances which are arranged in a distributor or suchlike. In the simplest case, auxiliary switches are to be connected here to one another.

WO 2004/036784 A1 discloses a non-symmetrical message transmission system using an electrical near-field, which is provided with a transmitter comprising at least one coupling element, by way of which an electrical near-field is essentially dispersed. In this way, the message transmission system includes an already existing infrastructure element, which has an electrically conductive conductor element which is electrically isolated from earth, into which conductor element the electrical field is coupled. A receiver which has at least one coupling element decouples the field transmitted in the conductor element.

### SUMMARY OF INVENTION

It is an object of the present invention to create a communication system for exchanging data between electrical appliances in electrical installation engineering which is characterized by a simple topology and low installation complexity.

This object is achieved in accordance with the invention by the features of an independent claim. Advantageous embodiments are the subject matter of additional claims in each instance.

It is possible to dispense with a complicated wired communication network on the one hand and a complex and thus interference-prone radio network on the other hand by means of the data transmission between electrical appliances using electrical fields with a high-frequency AC current, which are impressed on electrically conductive elements which are present in the installation arrangement, if applicable elements which are electrically isolated from one another by means of transmission means of the appliances and/or are tapped off from the elements by receiving means of the appliances. As a result and contrary to conventional communication systems, like for instance in the European Installation Bus, the Local Operating Network or Powerline, no control lines and/or network lines are needed for signal transmission. Instead, it is possible to profit from a communication system with a simple design and low installation complexity, which is also brilliantly suited to retrofitting.

With a near-field communication of this type, the data transmission system has a transmitter, with the coupling element of which an electrical near-field is essentially emitted. This field is capacitively coupled into an electrically conductive element, in which a current, in particular a pulse-like displacement current, then occurs at the electrically conductive element as a result of a change in charge. The electrically conductive element is electrically coupled to the earth potential and if applicable is capacitively coupled to additional electrically conductive elements. An electric circuit is formed by suitably capacitively coupling and decoupling a signal by means of such an element and if necessary by means of additional elements via coupling capacitors and coupling resistors which are present between the same and the earth potential including appliances which are able to communicate.

A potential difference between the electrically conductive element and earth can now be measured at any point of one of the electrically conductive elements using suitable receiving means and a signal can thus be received. The signal, which can be executed for instance as a control, status or also command signal, generally includes a data telegram and is used here for example to charge an actuator, an electronic signal amplifying circuit or also an electromechanical signal amplifying device, for instance a relay. A status, control or also load current circuit can be switched on or off for connecting display elements, control devices and/or consumers. Electrical devices which are able to communicate, like for instance safety switch devices, circuit breakers, residual current circuit breakers, power switches, motor protection devices, contactors, relays, switching and control devices, auxiliary switches, remote switches, time switches, display devices as well as electronic units, are typically used in a communication system in a distributor or control cabinet.

It is essential here for the signal frequency, electrically conductive elements and transmitters/receivers to be attuned to one another such that a near-field communication actually takes place, with no radio link with a predominant emission of the signal via the interior of a housing or a system part being present, but instead a predominantly capacitive coupling to electrically conductive elements actually taking place, which must however be provided in such a way that a signal with an adequate signal level can be received at a provided receiving site.

The losses of a radiating system are sometimes avoided using the inventive system and a very low current consumption is thus achieved in the transmitter and receiver. During transmission, no widely propagating unwanted scatter fields are produced, since the capacitive coupling from the transmitter into the electrically conductive element takes place through an electrical near-field with an only minimal coverage. The main losses arise here in the coupling capacitors and coupling resistors between the different conductive elements as well as by the self inductors of these elements.

A signal transmission in the quasi-stationary electrical field does not require a timing extraction on the receiver side, since the system clock is fed uniformly into the transmission medium, in particular into the electrically conductive elements. Basically, the usual methods of radio technology, like carrier preparation, modulation, multiplex methods, reception and demodulation can however be used in an unrestricted manner.

In one embodiment of the communication system, this has a metal housing containing the appliances, said metal housing being used as an electrically conductive coupling element for data transmission purposes. Contrary to a classical radio system, in which a metal housing of this type is more likely a hindrance for the propagation of a radio signal as a result of reflections deleting the signal and an effect shielding the signal, said disadvantageous shielding effect can surprisingly be converted into an advantageous coupling effect which is beneficial to a functional communication system. Similarly, metal struts and/or metal top hat rails as part of the housing contribute to forwarding the communication signals.

The data transmission between the appliances able to communicate advantageously takes place directionally or bidirectionally; depending on equipping the appliances with functional modules, transmitters, receivers or a combination of transmitters or receivers are optionally provided, as a result of which the most varied of functions can be executed.

The advantageous use of the frequency band between 5 MHz and 50 MHz for the high-frequency AC current results in electronic transmitter and/or receiver circuits used in the appliances being able to be executed in current-saving CMOS technology and the coupling elements, the dimensions of which are to be less compared with the wavelength of the AC current, have the maximum size of conventional rail mounted devices. The use of a frequency of 13.56 MHz and/or 40.68 MHz for the high-frequency AC current is particularly favorable. These frequencies lie in a so-called ISM band, in other words a frequency range released for industrial, scientific and medical applications with a general authorization which is not subject to governmental regulations and may be used without requiring a license. Only requirements relating to the transmission power and the interference of adjacent frequency. ranges must be adhered to. Appliances which operate in this frequency band can be put into operation immediately by the user without individual authorization having to be sought prior to initial commissioning.

The communication system can be used advantageously as part of a communication arrangement, in which a communication unit arranged outside the housing is provided with means for capacitive data transmission, which, in terms of a near-field communication, is capacitively coupled to the means for data transmission of the appliances using electrically conductive infrastructure elements. All entities which have electrically conductive elements can be used as infrastructure elements and this includes for instance heating pipes, current lines used in other ways, or electrically conductive foils, so that it is possible to dispense with lines to be installed specifically for the communication network. In instances in which the present infrastructure is not adequate for signal forwarding purposes, electrically conductive layers can be applied to walls, systems, modules and such like in the simplest fashion with minimal effort using inter alia rollers, spray or a brush, said layers improving the conductivity of the system.

### BRIEF DESCRIPTION OF THE DRAWINGS

The invention as well as advantageous embodiments according to the features of the additional claims are described in more detail below on the basis of exemplary embodiments illustrated in the drawing, without this resulting in a restriction of the invention, in which;

FIG. 1 shows a schematic representation of a communication system;

FIGS. 2, 3 show two variants of a communication arrangement having an inventive communication system, and

FIG. 4 shows an electrical equivalent circuit diagram of the inventive communication system.

### DETAILED DESCRIPTION OF INVENTION

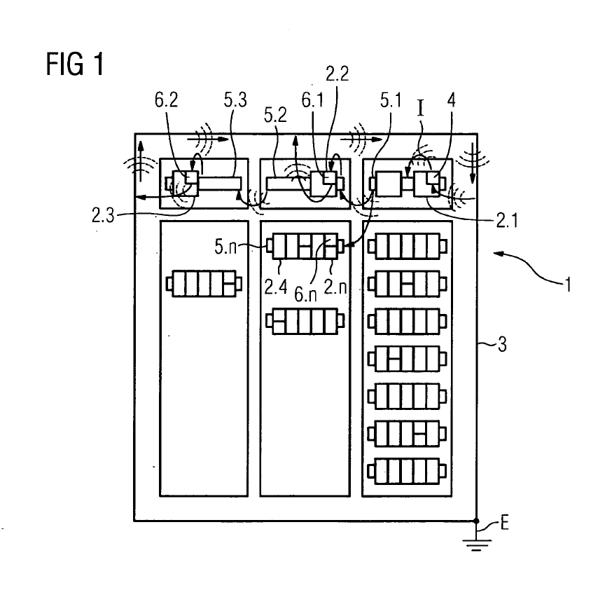

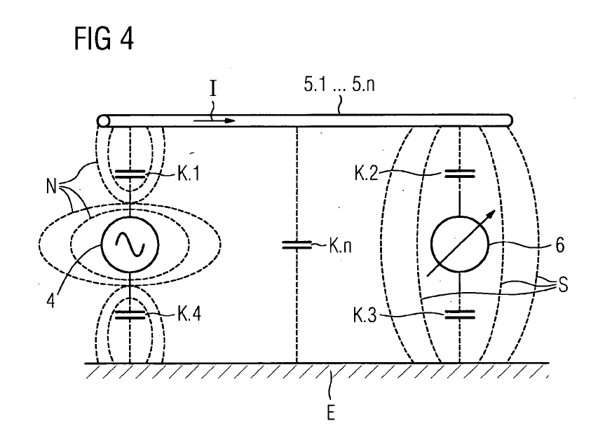

FIG. 1 shows a communication system 1 for exchanging data between electrical appliances 2.1 to 2.n, in particular rail mounted devices, in electrical installation engineering, which are arranged within a housing 3. A signal generator 4, which is integrated into the appliances, is used as a means of communication. A frequency or pulse generator can be used as a signal generator 4 for changing the charge for instance. In contrast to conventional appliances, the illustrated appliance 2.1 thus has a transmitter and a coupling element as part of the communication means, with which a quasi-stationary near-field N according to FIG. 4 can essentially be generated and/or emitted. A quasi-stationary near-field N is understood to mean a field, which is generated when a signal source and a coupling element distanced therefrom interact and has a predominantly electrical near-field component.

This field is asymmetrically coupled to the top hat rail 5.1 of the housing 3. Aside from a top hat rail 5.1, additional electrically conductive elements, in particular top hat rails 5.2 to 5.n are present in the housing 3, which are predominantly capacitively coupled to one another and to the earth potential E. The asymmetrical coupling of a high-frequency AC current I into the top hat rail 5.1 now forms an electric circuit across the additional conductive elements 5.2 to 5.n and the coupling capacitors and coupling resistors K which are present between the same and the earth potential E, as shown in FIG. 4. In this context, asymmetrical coupling means that the coupling capacitor between a coupling surface and the electrically conductive element or medium and/or between a coupling surface and the earth potential E is different in each instance and a potential difference can thus arise.

The asymmetrical coupling of the high-frequency AC current I produces a quasi-stationary scatter field S according to FIG. 4, which is emitted by the electrically conductive elements 5.1 to 5.n. A quasi-stationary scatter field S is understood to mean a field which is generated if the electrically conductive elements 5.1 to 5.n arranged in an undefined manner and a signal detector 6 distanced therefrom interact and which has a predominantly electrical near-field component. A potential difference can subsequently be measured and thus the signal received using suitable receiving elements 6.1 to 6.n at any point in one of the elements 5.1 to 5.n, in particular using a high-resistance signal detector 6 or also using a radio receiver integrated into the respective appliance. An actuator, which is part of the receiver or is connected thereto as a module, subsequently takes over the switching process, for example in order to close a load current circuit for a consumer. The system components comprising signal generator, signal detector as well as the actuators can be operated fed by the mains supply or a battery.

The frequency of the high-frequency AC current I, which has to be selected such that the transmission properties of the elements 5.1 to 5.n reach an optimum is essential here. Appliances which are able to communicate bidirectionally are equipped with transmitting and receiving means. By way of example, an advantageous application can consist in querying parameters or function states of circuit breakers, for instance, which are present in switching systems, and transmitting them to a visualization system.

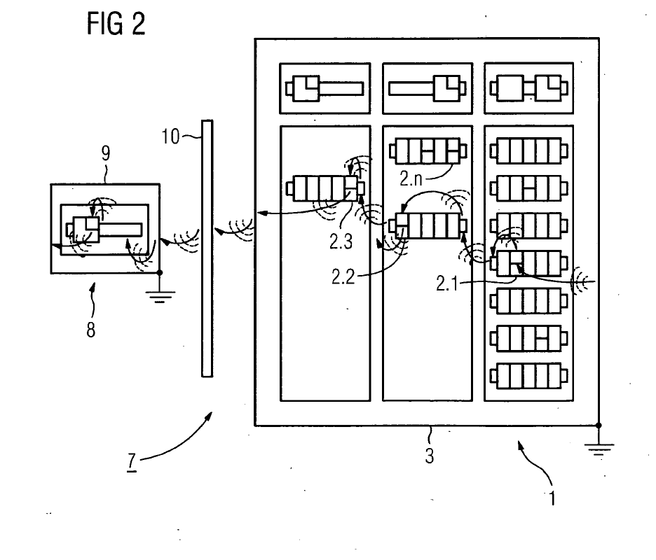

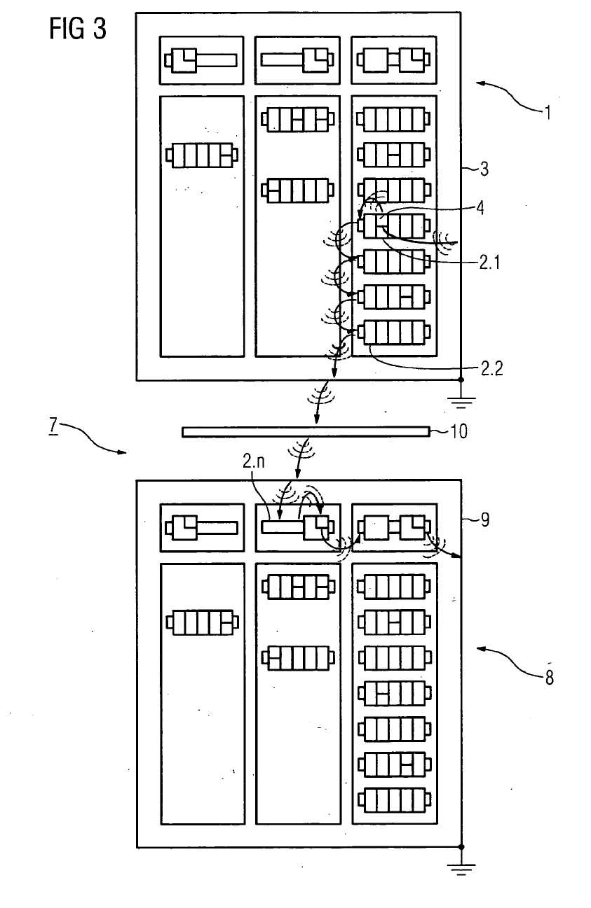

A communication arrangement 7 is shown in FIGS. 2 and 3 in each instance, which is provided with a communication system 1 according to FIG. 1. Here the exchange of data between the appliances 2.1 to 2.n is not restricted to the space within the housing 3, but instead extends using the electrically conductive housing 3 or corresponding components of the same to a communication unit 8 having its own housing 9, which is connected to the earth potential E. It is advantageously possible here to dispense with receiving units arranged outside the housing 3.9m, which would, if applicable, be necessary for data transmission in the case of conventional communication systems.

With a small distance, in other words in the near-field range, data transmission takes place directly between the two housings 3 and 9 and/or with a large distance, takes place indirectly via existing infrastructure elements 10, which may be electrically conductive per se or are provided with electrically conductive elements and are capacitively coupled to one another in the near-field range.

In both exemplary embodiments, the respective unit 8 according to FIG. 2 represents a DCF-77 receiving unit and in accordance with FIG. 3 an additional current distributor. Radio clocks are supplied with the central-European time by way of a radio signal using DCF-77 technology. The DCF-77 receiving unit must be attached outside the metallic housing 3 or metallic housing 3 provided with metallic elements, so that the radio signal is not shielded therefrom. So that a clock timer arranged in the housing 3 is supplied with the time data, the described electrical near-field communication is used by using the elements shielding the radio communication but however being useable for data transmission. A capacitive transmission of signals via additional paths to a subdivision which is unfavorable for conventional radio systems and finally to function units located therein is thus possible.

The transmission properties of the existing elements can be improved by assembling additionally conductive elements, like for instance an electrically conductive foil. In the case of electrical installation systems, this film is advantageously attached to the extent of the conventionally installed current distributor in the form of a circumferential band, so that good coupling characteristics are ensured. Instead of the foil, a metallic grid is also conceivable, which is incorporated into the plaster prior to application. One particularly simple application of the electrically conductive infrastructure element 10 is then provided if electrically conductive coatings are used, which can be applied to the wall by way of rollers, spray or brushes for instance. It is thus also possible to significantly improve electrically problematical ratios in a simple fashion.

FIG. 4 shows an exemplary equivalent circuit diagram of the communication systems and/or arrangements having means for near-field communication according to FIGS. 1 to 3. The electrical near-field communication taking effect here is based on an electric circuit comprising a displacement current I, which is closed at electrically conductive media or elements 5.1 to 5.n and the earth potential E by means of capacitively coupling K.1 to K.n of the signal generator 4 and of the signal receiver 6, if necessary including a consumer. A near-field N and a scatter field S are formed in the region of the transmitter 4 and the receiver 6 respectively. The coupling resistors K.n are not avoidable within the system, but are however known and can thus be considered in terms of system design. The smaller the coupling resistors K.n, the more reliable the message transmission.

In the present exemplary embodiments, frequencies of 13.56 MHz and/or 40.68 MHz are selected for the high-frequency AC current I. These frequencies lie in a frequency band released for industrial, scientific and medical applications, a so-called ISM band.

The previously explained invention can be combined as follows:

To create a communication system 1 for exchanging data between electrical appliances 2.1 to 2.n in electrical installation technology, which is characterized by a simple topology and a low installation complexity, provision is made to couple in terms of signaling to electrically conductive elements 5.1 to 5.n which are present in the installation arrangement using quasi-stationary electrical fields N and/or S with a high-frequency AC current, within the context of a capacitive near-field communication.

The communication channel provided by the communication system 1 provides for the use of existing metallic structures 5.1 to 5.n of an installation housing 3 for instance for data transmission. Metallic structures 5.1 to 5.n of this type, which specify technical difficulties in conventional radio technology in respect of practicability, are surprisingly beneficial with the inventive communication system 1. A suitable frequency selection allows the fail safety of a wired system to be achieved as far as possible without a separate line installation. The avoidance of lines which are conventionally to be installed for connecting different appliances reduces the installation complexity to a significant degree.

1-16. (canceled)

17. A communication system for exchanging data between electrical appliances in electrical installation engineering, comprising:
electrical appliances; and
a housing with at least one electrically conductive element, in which the appliances are arranged, which each comprise a device for data transmission, of which at least one device for transmitting data of a first appliance is asymmetrically coupled to the at least one electrically conductive element of the housing such that a quasi-stationary near-field with a high-frequency AC current is impressed thereon, with a quasi-stationary scatter field resulting therefrom and having a high-frequency AC current being available at the at least one electrically conductive element of the housing and with at least one device for receiving data of an additional appliance being asymmetrically coupled to the at least one electrically conductive element of the housing such that the scatter field is tapped therefrom.

18. The communication system as claimed in claim 17, wherein the electrical field is capacitively coupled into the at least one conductive element and is capacitively decoupled therefrom.

19. The communication system as claimed in claim 17, wherein the electrical field is capacitively coupled into the at least one conductive element and is electrically decoupled therefrom.

20. The communication system as claimed in claim 17, wherein the electrical field is electrically coupled into the at least one conductive element and is capacitively decoupled therefrom.

21. The communication system as claimed in claim 1, wherein the appliances are selected from the group consisting of a switch device, a safety switch device, a circuit breaker, and a residual current circuit breaker.

22. The communication system as claimed in claim 17, wherein at least one electrically conductive element is a metal housing, a metal housing strut and/or a metal top hat rail.

23. The communication system as claimed in claim 17, wherein at least one electrically conductive element is a current distributor or a control cabinet.

24. The communication system as claimed in claim 17, wherein the data transmission is performed based upon a transmitter and a receiver.

25. The communication system as claimed in claim 17, wherein the data transmission is directional.

26. The communication system as claimed in claim 17, wherein the data transmission is bidirectional.

27. The communication system as claimed in claim 17, wherein the frequency of the high-frequency AC current lies in the range of 5 to 50 MHz.

28. The communication system as claimed in claim 17, wherein the frequency of the high-frequency AC current lies in the range of 13.56 MHz or 40.68 MHz.

29. A communication arrangement, comprising:
a communication system for exchanging data between electrical appliances in electrical installation engineering, having
electrical appliances, and
a housing with at least one electrically conductive element, in which the appliances are arranged, which each comprise a device for data transmission, of which at least one device for transmitting data of a first appliance is asymmetrically coupled to the at least one electrically conductive element of the housing such that a quasi-stationary near-field with a high-frequency AC current is impressed thereon, with a quasi-stationary scatter field resulting therefrom and having a high-frequency AC current being available at the at least one electrically conductive element of the housing and with at least one device for receiving data of an additional appliance being asymmetrically coupled to the at least one electrically conductive element of the housing such that the scatter field is tapped therefrom; and
a communication unit arranged outside the housing and a data transmitter, which, in terms of near-field communication by means of electrically conductive infrastructure elements is coupled to the device for data transmission of the appliances.

30. The communication arrangement as claimed in claim 29, wherein the communication unit is embodied as an additional appliance or an additional appliance arrangement in a separate housing.

31. The communication arrangement as claimed in claim 29, wherein the communication unit is situated in a distributor cabinet.

32. The communication arrangement as claimed in claim 29, wherein the communication unit is situated in a control cabinet.

33. The communication arrangement as claimed in claim 30, wherein the additional appliance is a receiver of a radio clock signal.

34. The communication arrangement as claimed in claim 30, wherein the additional appliance is a DCF-77 receiver.

35. The communication arrangement as claimed in claim 29, wherein the electrically conductive infrastructure elements are water pipes, heating pipes, metal struts, metal foils or power lines.

36. The communication arrangement as claimed in claim 29, wherein the electrically conductive infrastructure elements are electrically conductive layers applied using rollers, spray, brushes or suchlike.

37. The communication arrangement as claimed in claim 29, wherein the electrically conductive infrastructure elements are installed in or under plaster.
